(19) United States
(12) Patent Application Publication
(10) Pub. No.: US 2011/0055210 A1
(43) Pub. Date: Mar. 3, 2011

(54) Robust Adaptive Data Clustering in Evolving Environments

(75) Inventors: Roger W. Meredith, Slidell, LA (US); Marlin L. Gendron, Pass Christian, MS (US); Bryan L. Mensi, Picayune, MS (US)

(73) Assignee: The Government of the U.S.A., as represented by the Secretary of the Navy, Washington, DC (US)

(21) Appl. No.: 12/552,495

(22) Filed: Sep. 2, 2009

(51) Int. Cl. G06F 17/30

(52) U.S. Cl. 707/737; 707/E17.046

(57) ABSTRACT

A computer-implemented method for automated data clustering and analysis. A computer takes a database having multiple entries and transforms the entries in the database into a set of intrinsic attributes for each entry. The computer then receives data defining one or more clustering trials to be run on the attributes from the entries in the database, each clustering trial being defined by a set of relevant intrinsic and extrinsic attributes. The computer automatically identifies the most significant intrinsic and/or extrinsic attributes of the entries being clustered for each clustering trial, and runs a clustering script to cluster the attributes in accordance with the significant attributes. The computer forms hierarchical linkages of the profiles and automatically calculates the cophenetic correlation coefficient for the linkages in each clustering trial. The invention then automatically calculates linkage threshold values for the linkages in each trial, creates cluster groups based on the threshold values, and outputs dendrograms and maps showing the results.

### TECHNICAL FIELD

The present invention relates to computer-implemented automated data analysis and clustering.

### BACKGROUND

In our information-based age, many organizations have developed and maintain very large databases of information. Analyzing the information in such large databases can be cumbersome and time consuming, and may not always produce useful results. Grouping the data into classes or categories often can help to describe similarities and differences in data in a way that helps understanding and describes relationships.

Clustering is a commonly used method in many fields of both pure and social sciences for these purposes, and can also provide weight or significance to each group, identify a subset of data that best represents the database, predict properties of new data, and identify data that are least similar to the rest of the database. Basic principles of data clustering are described in Jain et al., “Data Clustering: A Review,” ACM Computing Surveys, Vol. 31, No. 3, pp. 264-323 (September 1999), the entirety of which is incorporated by reference herein.

Histograms are a simple form of data clustering, where data values are binned into a small subrange, often into 100 bins called percentiles. The number of data values in each percentile is counted and a plot generated of bin vs. count. More sophisticated clustering replaces the histogram concept by transforming the data into multiple attributes (or types of data values) and computing measures of distance between data entries to form linkages based on the computed distances, and can be very useful for dealing with large databases.

One such large database is the environmental database of temperature-salinity-depth profiles known as the Master Oceanographic Observation Data Set (MOODS) database maintained by the Naval Oceanographic Office (NAVOCEANO). This database contains over 8 million profiles from around the world, covering a time period that spans over 125 years. The individual profiles are a snapshot record of the evolving environment over several time intervals and rates-of-change spanning an area of interest. Because sound speed can be calculated from temperature-salinity-depth data, using the data from the MOODS database, NAVOCEANO also generates and maintains seasonal and regionalized sound speed profiles for areas of Naval interest. These sound speed profiles contain a number of intrinsic attributes such as surface temperature, mixed layer depth, median sound speed, and depth at which that median sound speed occurs. These profiles also are associated with a number of extrinsic attributes that also may be relevant to sound speed. For example, ocean temperature and salinity vary under many forcing functions including depth, tides, wind stress, waves, solar heating, atmospheric pressure, current, voracity, and Earth's rotation. Because of these intrinsic and extrinsic attributes, sound speed is constantly evolving over a large range of spatial and temporal scales ranging from turbulent scales (less than a second and smaller than a meter) to synoptic scales (days and months over ranges of tens of thousands of meters). Thus, the sound speed profiles also are evolving, changing over many time and spatial scales.

Categorizing these sound speed profiles into groups stems from the desire to locate and identify the causes of sound speed spatial variability. The principal objective of such grouping is to identify geographical areas where sound speed profiles are consistent over some defined set of attributes and to quantify sound speed variability within each such profile group and between each group. In addition, information regarding the geographic location, extent, and separation of these profile groups might be interesting in itself and may provide new descriptions of large-scale variability that, in some manner, comprises the results of all the forces involved in variability of the physical properties of the ocean.

Thus, clustering of data such as the Navy's sound speed profiles can provide numerous advantages.

### SUMMARY

This summary is intended to introduce, in simplified form, a selection of concepts that are further described in the Detailed Description. This summary is not intended to identify key or essential features of the claimed subject matter, nor is it intended to be used as an aid in determining the scope of the claimed subject matter. Instead, it is merely presented as a brief overview of the subject matter described and claimed herein.

The present invention provides a computer-implemented method for automated data clustering. In accordance with the present invention, a computer takes a database having multiple entries and transforms the entries in the database into a set of intrinsic attributes. The computer then receives data defining one or more clustering trials to be run on the entries in the database, each clustering trial being defined by a set of relevant intrinsic and extrinsic attributes. The computer automatically identifies the most significant intrinsic and/or extrinsic attributes of the entries being clustered, and runs a clustering script for each clustering trial to cluster the attributes in accordance with the significant attributes. Using standard hierarchical clustering, the computer forms hierarchical linkages of the profiles based on the distances between the intrinsic and extrinsic attributes for each profile, and automatically calculates the cophenetic correlation coefficient c for the linkages in each clustering trial. The invention then automatically calculates linkage threshold values for the assignment of database entries into cluster groups, creates cluster groups based on the threshold values and outputs dendrograms showing the results of the clustering of the profiles and an identification of the cluster groups.

### BRIEF DESCRIPTION OF THE DRAWINGS

FIG. 1 provides an overview of an exemplary process flow for computer-implemented automated data clustering in accordance with the present invention.

FIG. 2 depicts an exemplary process flow for computer-implemented automated hierarchical data clustering in accordance with the present invention.

FIGS. 3A-3C depict exemplary attribute matrices showing the intrinsic (FIG. 3A) and extrinsic attributes (FIG. 3B) for each profile (row) which are combined into a final matrix (FIG. 3C) of attributes used in data clustering in accordance with the present invention.

FIGS. 4A and 4B depict exemplary aspects of hierarchical clustering used in accordance with the present invention. FIG. 4A depicts aspects of clustering of attributes based on the distance between vectors. FIG. 4B depicts an exemplary dendrogram showing the results of the clustering shown in FIG. 4A.

FIG. 5 depicts an exemplary process flow for calculation of linkage threshold values and creation of cluster groups in computer-implemented automated hierarchical clustering in accordance with the present invention.

FIGS. 6A-6D depict exemplary dendrograms with different linkage results for different threshold linkage values applied to a single cluster trial performed in accordance with the present invention.

FIGS. 7A-7C depict exemplary dendrograms showing different linkage results for different cluster trials performed in accordance with the present invention.

FIGS. 8A-8D depict exemplary plots of database entries in four different data clusters derived in accordance with the present invention.

FIG. 9 depicts an exemplary geographical mapping of database entries according to data clusters derived in accordance with the present invention.

### DETAILED DESCRIPTION

The invention summarized above can be embodied in various forms. The following description shows, by way of illustration, combinations and configurations in which the aspects can be practiced. It is understood that the described aspects and/or embodiments of the invention are merely examples. It is also understood that one skilled in the art may utilize other aspects and/or embodiments or make structural and functional modifications without departing from the scope of the present disclosure.

For example, although the methods for automated data clustering are often described herein in the context of clustering of sound speed profiles in the Navy's MOODS database, one skilled in the art will readily appreciate that the methods for automated data clustering described herein may be used in connection with any type of database having multiple two-dimensional profiles or N-dimensional data. In addition, although the methods for automated data clustering are described herein in the context of MATLAB programming protocols and use of a MATLAB script, one skilled in the art will readily appreciate that any other appropriate programming language and/or protocols can be used to perform the methods for automated data clustering in accordance with the present invention.

The present invention provides a computer-implemented method for fully automated data clustering based on transforming data base profile entries into attributes to be clustered in the study and/or description of the evolution of the profiles over time intervals and rates-of-change inherent in the database. The individual profiles are a record of the evolving environment over time intervals spanning an area of interest. Through a series of operator decisions, the evolving scales of location, depth, and time are constrained (within the limits of the spatial and temporal scales and densities of the database.) The environmental profiles are clustered over the selected spatial and temporal ranges and partitioned, thus revealing and quantifying the separation, similarities, differences, and patterns (groups) in the original data entries.

As will be appreciated by one skilled in the art, such a method for automated data clustering can be accomplished by executing one or more sequences of computer-readable instructions read into a memory of one or more general or special-purpose computers configured to execute the instructions. Any one of such computers can include one or more of a processor, volatile memory, non-volatile memory, a graphics renderer, and a display or other output mechanism such as a printer. In addition, as noted above, although one embodiment of the present invention utilizes MATLAB software and programming protocols, one skilled in the art would readily appreciate that the form and content of the instructions that can be used to accomplish the steps described herein can take many forms, and all such instructions, irrespective of their form and/or content, are within the scope of the present disclosure.

As described in more detail below, a computer-implemented method for automated attribute-based adaptive data clustering in accordance with the present invention takes a database of individual profiles, automatically transforms them into a separate database of mission-specific attributes, and the automatically clusters the attributes to obtain spatial and temporal maps of the environment. The method of the present invention also provides automatic adaptive attribute selection, linkage threshold determination, rankings and other analysis of cluster linkages, and proportioning into cluster groupings for any one or more clustering trials. In addition, due to the use of principal component analysis in identifying the most significant attributes of the data to be clustered, data clustering is more robust and better reflects the nature of the underlying physical phenomena represented by the data.

To accomplish these ends, the method for automatically clustering data in a database in accordance with the present invention conducts one or more clustering trials using hierarchical clustering, automatically analyzes and evaluates the results of the clustering trials to identify those that best reflect the underlying physical phenomena represented by the data, automatically creates cluster groups of the data, presents the results of the clustering for display, and/or uses the results of the clustering to generate additional displays providing further information to the user. These and other aspects of the invention will be described in more detail below.

When clustering data such as sound speed profiles, ideally the cluster groups would be solely based on intrinsic attributes transformed from the profiles themselves. However, the dependence of sound speed profiles on so many extrinsic factors and environmental effects related to location and time implies that a combination of intrinsic profile characteristics and extrinsic spatial and temporal indicators are needed to accurately categorize the profile data. Extrinsic attributes also are useful in determining mission- or application-specific subsets of larger databases and can provide parameters needed to quantify the evolution of profiles over space and time.

Thus, clustering sound speed profiles using both intrinsic and extrinsic attributes can provide new insights into the spatial and temporal factors that affect sound speed.

The results of sound speed profile clustering can be used to create cluster-based maps which show where the sound speed is similar or where it varies in similar ways due to similar topography. These maps display the evolution of sound speed over spatial and temporal scales selected by the user. Uses for these cluster maps and group results can be easily imagined. For the U.S. military mine countermeasures (MCM) and meteorological and oceanographic (METOC) communities, sound speed profile clustering can provide a new planning tool by identifying the locations where significant sound speed changes historically occur, and the temporal and spatial scales of those changes. Knowing when and where sound speed is likely to change provides a strategic advantage. Maps of sound speed changes can alert the operator to potential sonar performance changes. Sound speed cluster maps can be tailored for a wide range of temporal scales (weeks, months, seasonally or annually) and spatial scales (local, regional, or continental scales). Such maps could aid in determining the frequency and location of needed or beneficial ship action, for example, in planning more efficient survey ship operations and conductivity, temperature, and depth (CTD) data collections. The profiles assigned to each cluster group can be used to predict the effect of sound speed changes on sonar system performance as the sonar transits from one cluster group to another and to predict sonar performance due to profile variability within a single cluster group. This information would provide the tactical planner both a range-of-the-day value (from an in-situ CTD measurement) and the likely deviations due to the variability within the corresponding cluster group.

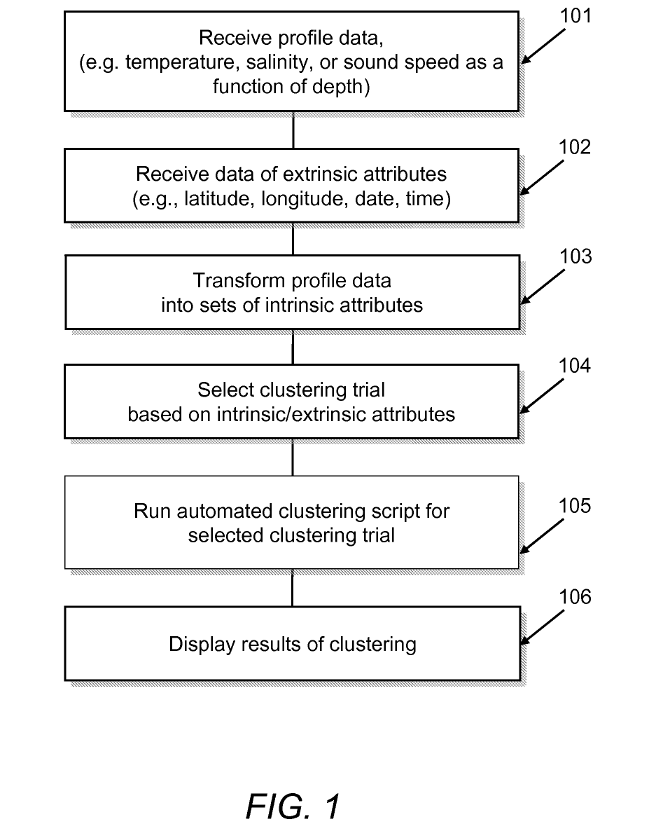

FIG. 1 provides an overview of an exemplary process flow in a method for of automated attribute-based adaptive data clustering in accordance with the present invention. Again, it should be noted that although the process flow is described in the context of profiles in the Navy's Master Oceanographic Observation Data Set (MOODS) database, the method in accordance with the present invention can be used in connection with any database having multiple two-dimensional profiles or N-dimensional data. In addition, although the process flow is described in the context of multiple clustering trials being run, many aspects of a method for automatic clustering in accordance with the present invention can also be applied in cases where only one clustering trial is run.

As illustrated in FIG. 1, a computer-implemented process for automated attribute-based adaptive data clustering in accordance with the present invention begins at step 101 with the processor receiving a database of the profiles to be clustered, for example, profiles in the MOODS database. The MOODS database contains temperature, salinity, and depth profiles from which sound speed can be computed. Collectively, these profiles are often referred to as “sound speed profiles.” This data can be stored in any appropriate memory and received by the processor in any appropriate manner. For example, the data can be stored in volatile or non-volatile memory on the computer or in a remote database and be accessed by the processor at the start of a data clustering process or can be stored on removable media that is loaded onto the computer.

Data relevant to the clustering and analysis of these sound speed profiles include both intrinsic and extrinsic attributes. Intrinsic attributes are those that are inherent in the profile, e.g., sound speed, or that are transformed from the profile, e.g., the depth of the maximum derivative of the profile. Intrinsic attributes are thus in some way part of the essence of the profile, and so thus those intrinsic attributes is may be received along with the profiles at step 101 or transformed from each profile during step 103.

For example, the following intrinsic attributes can be obtained directly from the individual profiles in the MOODS database:
Mixed layer depth of the temperature profile
Surface temperature
Maximum depth to which the temperature profile extends
Median value of sound speed
Depth at which the median value occurs
Coefficient of variation of the entire sound speed profile
Depth Layers, e.g., the entire profile or any part of the profile allowing selective depth ranges

Additional attributes can be obtained through one or more types of mathematical transformations of the raw profile data. Such attributes can include:
Relative change in percentage to the surface sound speed
Integrated values of sound speed versus depth
Crude estimate of sound speed slope from the surface sound speed
Central moments estimated from the profile
Spatial correlation estimates from the profile
Fourier coefficients of the profile

In addition, the first and second numerical derivatives of the profile can be estimated and can provide the basis for additional transformed attributes. For example, from each derivative, the following exemplary additional attributes relating to the magnitude and coherence of the profile can be obtained:
Geometric mean
Coefficient of scintillation
Depth at which the maximum derivative occurs
Autocorrelation size and magnitude
Cross-correlation with a reference profile

The MOODS database also contains many types of extrinsic attributes for each profile. At step 102 in the exemplary process flow shown in FIG. 1, these extrinsic attributes of each profile are maintained as metadata in the database. These extrinsic attributes can include
Longitude of the profile
Latitude of the profile
Observation date and time
Instrument type
Quality code
Data originator
Number of samples in the profile
The ocean floor depth at the location of the profile
The minimum distance to land where the data was gathered
Tidal stage at time profile was acquired,
Sediment type of the ocean bottom at that location

At step 104 shown in FIG. 1, one or more clustering trials defined by combination of intrinsic and extrinsic attributes of the data are selected to be run. As described below, the definition of a clustering trial to be run can be based on an operator's direct selection of one or more intrinsic and extrinsic attributes, or can be a predefined trial for a specific mission or application that is loaded into the processor for execution. In addition, as described in more detail below, in some embodiments, the attributes forming a part of a clustering trial to be run can be selected on the basis of the results of principal component analysis performed on all of the attributes subject to clustering while in other embodiments, principal component analysis can be limited to selected intrinsic or extrinsic attributes.

For example, the following clustering trials can be predefined based on the extrinsic attribute of water depth:
Cluster based on a single depth layer for entire profile
Cluster based on a linear segmentation of depth layers, i.e., a layer every 20 m
Cluster based on a linear accumulation of depth layers, i.e. 0-20 m, 0-40 m, 0-60 m, etc.
Clustering for one or more depth ranges or one or more time ranges

Of course, many other clustering trials can be defined. For example, each profile in the database is partitioned into sequential (and cumulative) depth layers of varying thickness. This identifies profile locations of higher evolutionary activity from lower ones and also enables the automated adaptation to specific missions that are applicable to small regions of the profile. Thus, a clustering trial can be run for a specified selection of layers, e.g., any one or more of 0-20 m, 30-60 m, 75-100 m, etc., or one location and one depth over one or more specified periods of time.

As noted above, these or any other clustering trials can be defined manually by an operator or can be predefined automatically, either as part of a predefined stand-alone clustering script or in a clustering script forming part of a larger mission plan or application. The clustering trial also can be defined by spatial parameters (one or more geographic areas), temporal parameters (one or more time periods), depth parameters (shallow water, deep water, or a range or ranges of the water column), or for a specific purpose such as mine warfare (shallow water, high resolution thresholding) or antisubmarine activities (deep water, lower resolution thresholding). More complex examples can be predefined to limit the attributes to be near the surface (or near the bottom) spanning a specified length of time. Another predefined script might be for only the most active (evolving) portion of the profiles to compare variability with depth, time and location. In addition, other criteria can be used to determine at the outset which of the profiles should be included in the clustering. For example, in the case of clustering sound speed profiles for use in mine warfare applications, profiles that begin at a depth greater than 50 meters can be discarded because emphasis is placed on shallow water profiles. In other cases, profiles having fewer than a minimum number of samples can be discarded as not being statistically reliable for the mission's needs.

Irrespective of the manner in which the clustering trial is defined, in accordance with the present invention, after the evolving temporal and spatial scales of interest in the clustering trial have been defined, the processor can retrieve the relevant subset of profiles from the database and, as described below, can transform each profile into a vector of attributes and stack the attribute vectors together to form a matrix. Thus, in accordance with the present invention, the processor can take a database of individual profiles and transform it into a separate database of mission-specific attributes for use in clustering the profiles.

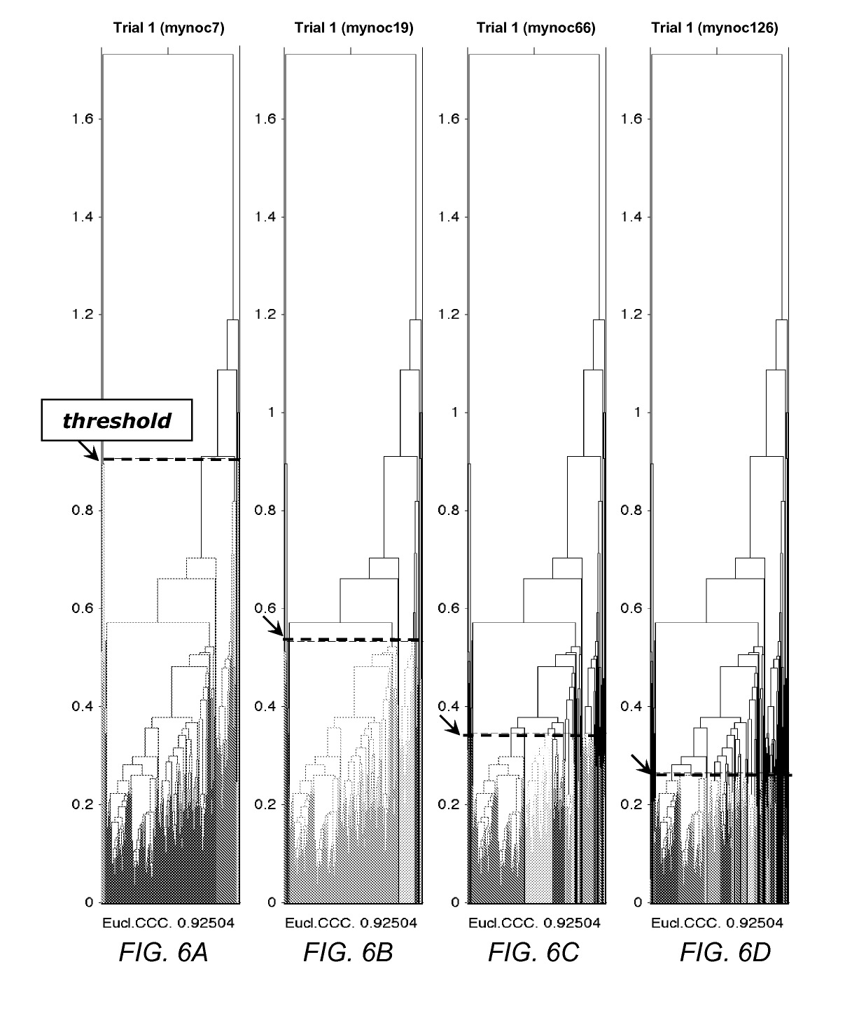

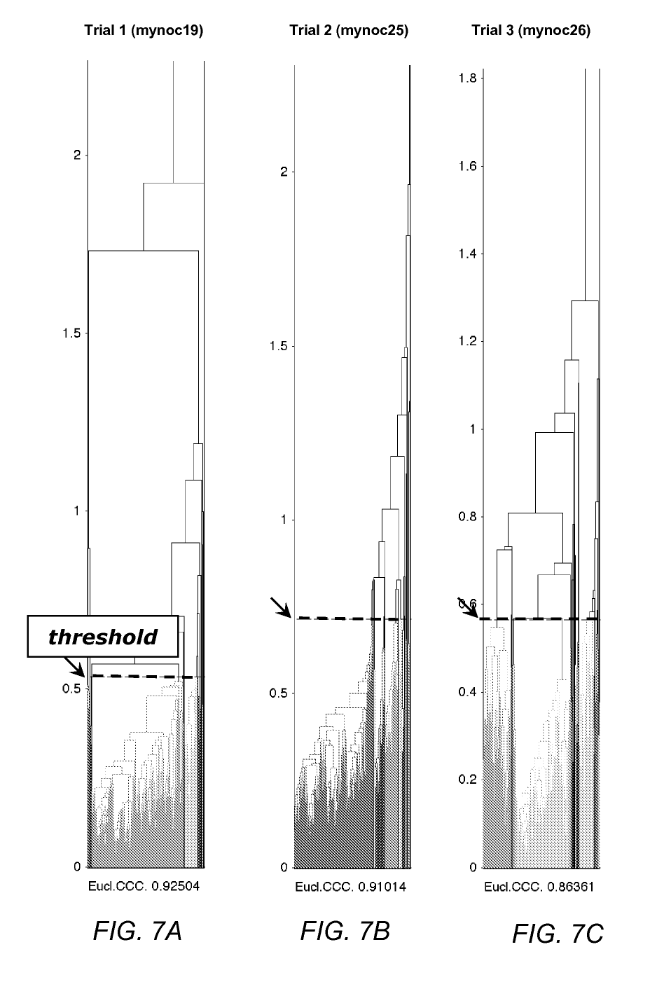

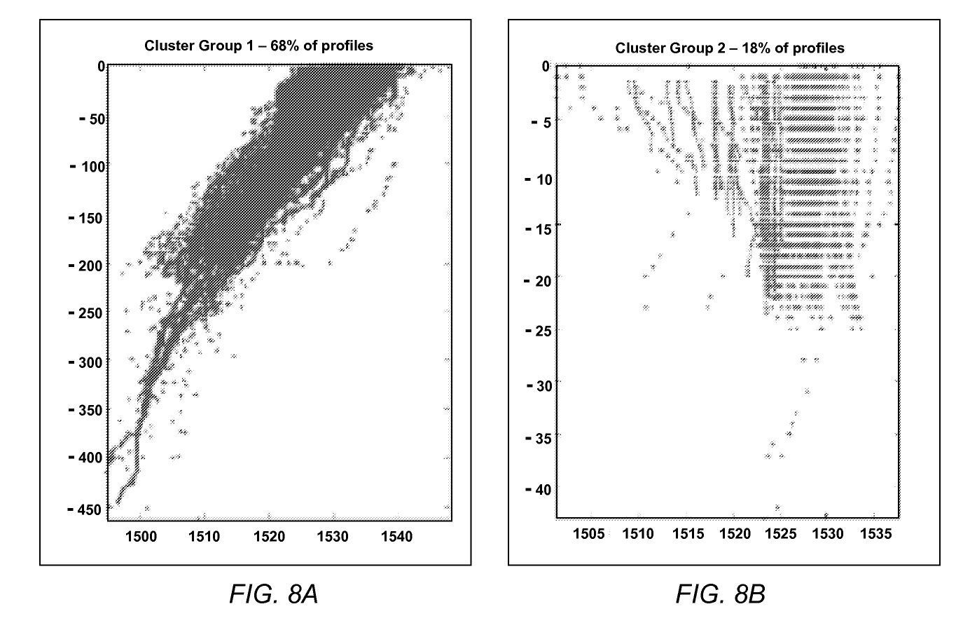

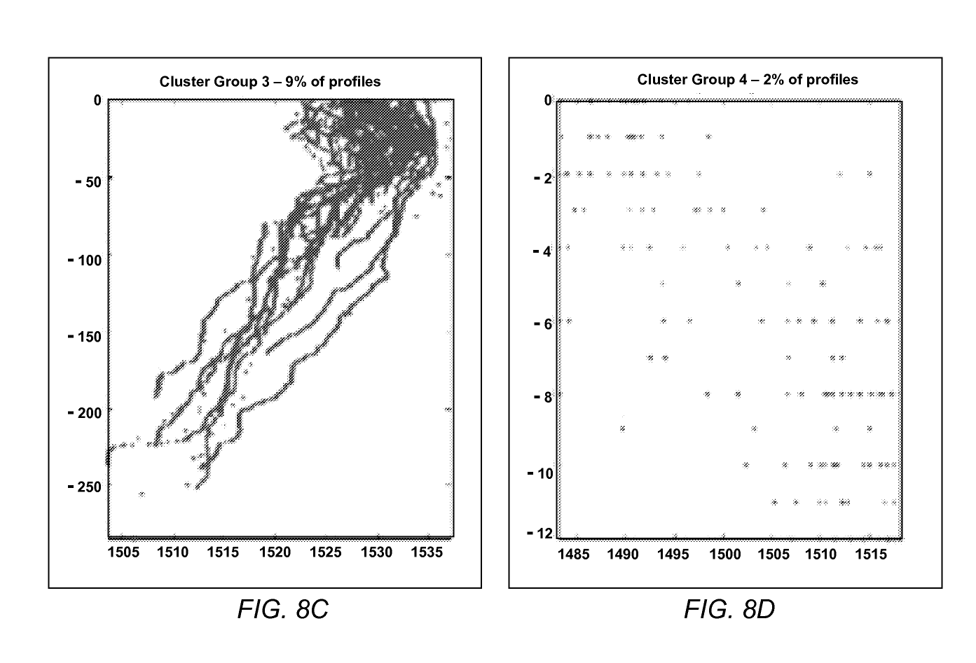

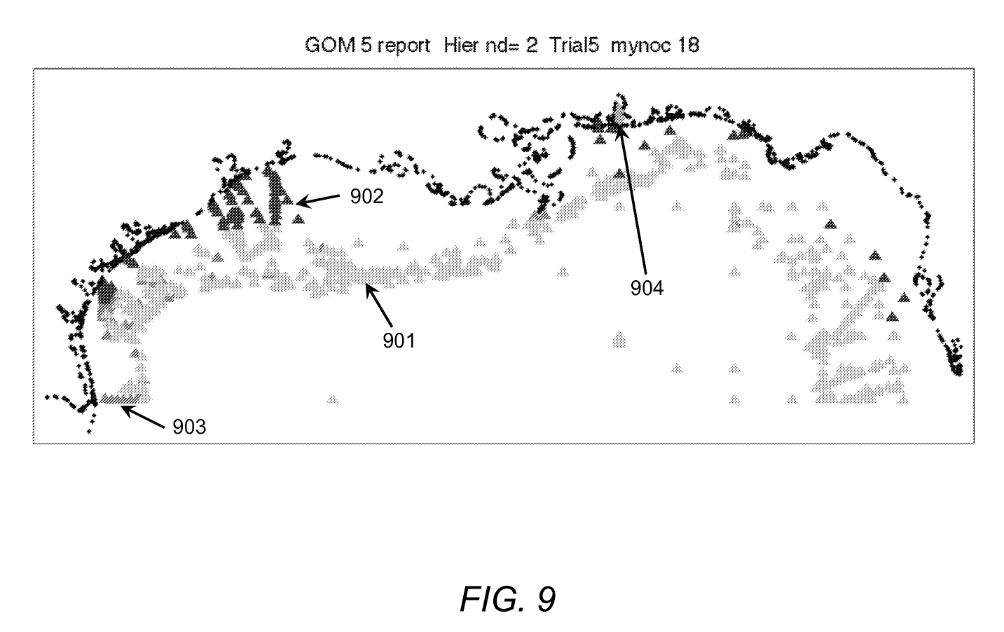

Once one or more clustering trial is selected, at step 105, in accordance with the method of the present invention and as described in more detail below, the computer runs an automated clustering script to cluster the data in the database based on the set of intrinsic and extrinsic profile attributes identified in the definition of the clustering trial. As described in more detail below, the choice of attributes used in a clustering trial can have a significant effect on the linkages and cluster groups created. The results of the automated clustering script are output at step 106 and can comprise one or more dendrograms such as those shown in FIGS. 6A-6D and 7A-7C showing the linkages of the profiles and the cluster groups identified in the process. The results of the automated clustering script can also include other mappings or displays such as those shown in FIGS. 8A-8D and FIG. 9 in which the cluster groups provide information regarding the behavior of sound speeds at different geographical locations.

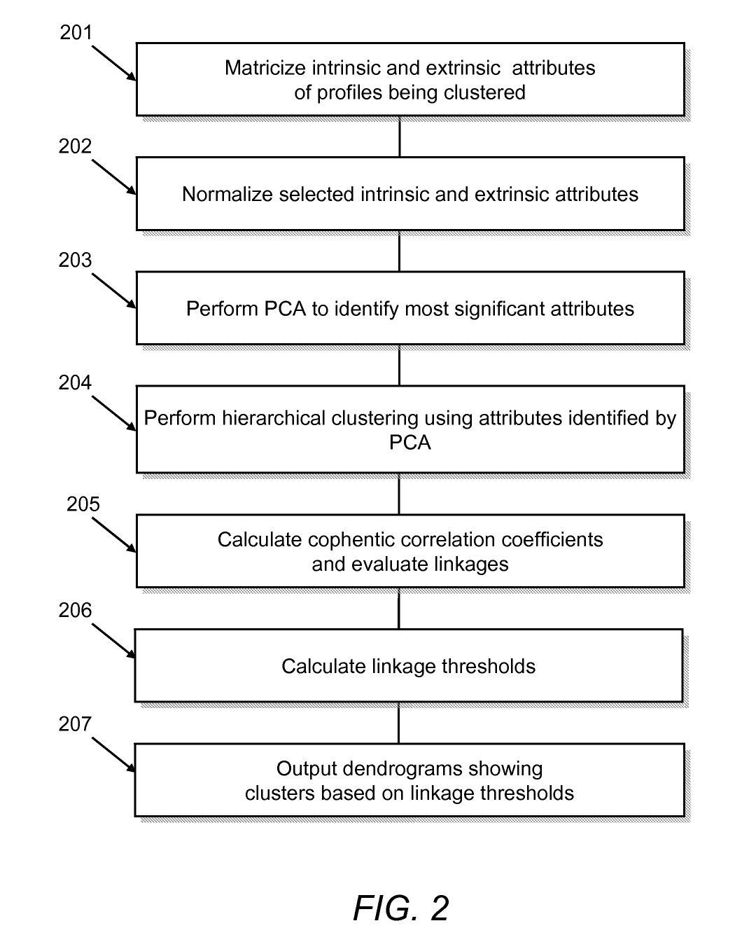

FIG. 2 depicts further details of an exemplary process flow for a clustering script used in a method for automated attribute-based adaptive data clustering in accordance with the present invention. Based on the clustering script, the processor can automatically select intrinsic attributes to be used in a clustering trial, automatically perform hierarchical linking based on the selected intrinsic attributes and the extrinsic attributes defining the clustering trial, automatically order the linkage results to identify the trials having linkages that most accurately reflect the data, automatically calculate linkage thresholds and creates cluster groups based on those linkage thresholds, and automatically output dendrograms or other displays showing those cluster groups. In some embodiments, described below, in accordance with the clustering script the processor can also automatically use the results of the clustering to generate additional graphical outputs such as maps showing the locations of cluster groups, where close proximity of multiple cluster groups indicates high variability over time or space.

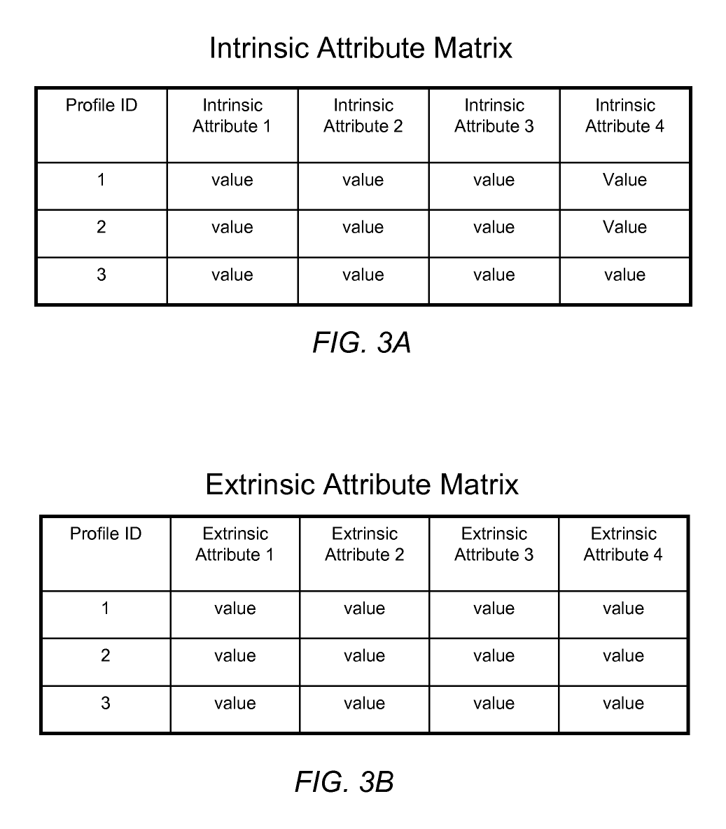

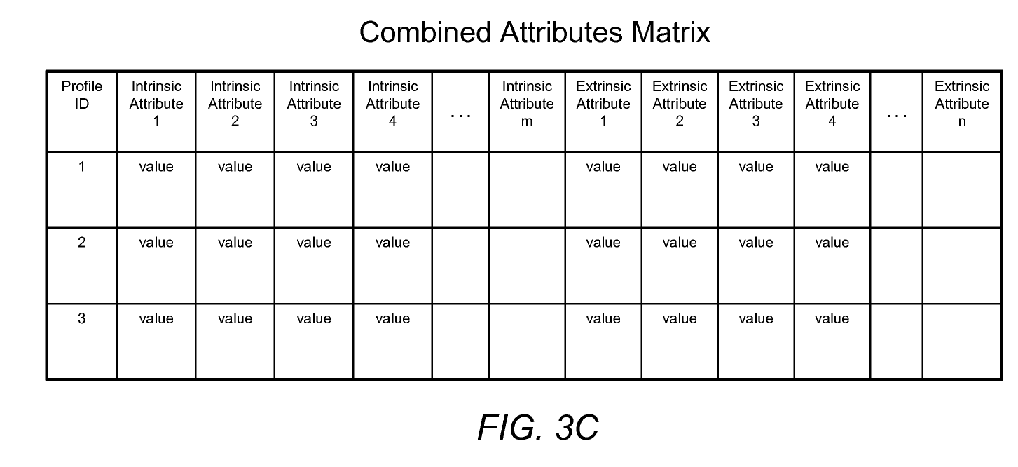

In the exemplary process flow shown in FIG. 2, at step 201, the processor matricizes the intrinsic and extrinsic attributes of the profiles, i.e., puts the attributes into a matrix form such as that shown in FIGS. 3A, 3B, and 3C, with each row representing an individual profile and each column an attribute from that profile. Thus, as described above, after the evolving temporal and spatial scales of interest in the clustering trial have been defined, the processor can retrieve the relevant subset of profiles from the database, transform each profile into a vector of attributes, and stack the attribute vectors together to form a matrix. FIG. 3A depicts an exemplary matrix of the intrinsic attributes relevant to the spatial and temporal parameters of the clustering trial, while FIG. 3B depicts an exemplary matrix of the relevant extrinsic attributes. These intrinsic and extrinsic matrices can then be combined into a final matrix of intrinsic and extrinsic attributes relevant to the clustering trial such as the combined attribute matrix shown in FIG. 3C. In some embodiments, attributes for evolving environments such as underwater environments can be partitioned by one or more extrinsic attributes, e.g., over selected ranges of time or location, or by selected ranges (or layers) of depths for the sound velocity profiles described herein, and thus the combined attribute matrix shown in FIG. 3C can include multiple partitions of attributes.

It should be understood that this matricization step is included in the present disclosure describing a MATLAB-based implementation of the method of the present invention, and this step might be omitted as appropriate in other implementations of the present invention using other applications.

Irrespective of the implementation, each of the attributes used for a clustering trial must have a finite value. The values can include simple descriptive values such as the maximum value of the attribute, the minimum value, the initial value, and the integrated value; values based on the distribution of values of the attribute in the profile; values based on the correlation of the attribute in a profile with a reference profile; values based on the first and second derivatives of the value of the attribute in the profile; and values based on any mathematical transformation of all or any of the attribute values in the profile. If data for a particular attribute is missing, the processor can implement any suitable methodology for filling in the missing value, and if the value cannot be supplied, the profile having the missing value can be discarded from the clustering trial.

At step 202 shown in FIG. 2, the values of the extrinsic and intrinsic attributes in the columns of the matrix can be normalized. Normalizing can be done by any method known in the art, and improves the overall clustering results by reducing the disparity in the magnitude scales of different attributes. Once the values of the extrinsic and intrinsic attributes are normalized, at step 2303 shown in FIG. 2, principal component analysis using any appropriate method known in the art can be performed on the combined matrix of intrinsic and extrinsic attributes to identify a subset of the attributes in the combined matrix that are most significant to the profiles being clustered. In an exemplary embodiment, the subset must include a minimum of three most significant attributes, though in other embodiments, a larger or smaller subset of attributes may be identified as being most significant.

Use of principal component analysis ensures that only those attributes which are more nearly statistically independent are used in clustering, and reduces the number of attributes that must be processed by the system, saving time and money. Moreover, identifying the most significant attributes via principal component analysis in accordance with the present invention permits the clustering to be adapted and optimized in a manner that is data-attribute dependent. For example, in the case of the clustering trial previously described in which the profiles are clustered using multiple depth layers (i.e., from 0-20 m, 20-40 m, 40-60 m, etc.), principal component analysis can be performed to identify the most significant attributes for those profiles specific to each layer. In some embodiments, principal component analysis can be applied to the combined matrix of intrinsic and extrinsic attributes, while in other cases it can be applied separately to the intrinsic and/or extrinsic attributes or applied separately to a subset of the attributes such as individual depth layers prior to combining all the selected attributes into one matrix for clustering. The set of attributes on which principal component analysis is to be applied can be chosen in any appropriate manner, e.g., be chosen by a user, be part of the predefined clustering script, or be defined by the mission parameters of which the clustering is a part.

Once the attributes to be used in the clustering trial are identified by principal component analysis, at step 204, hierarchical clustering can be performed on the combined set of matrix attributes originating from the definition of the clustering trial. Hierarchical clustering is known in the art, see, e.g., Jain et al., supra, and will not be described in detail here. Briefly, for each clustering trial the distance from each profile to every other profile is computed using a vector of the attributes defined for that clustering trial. Although the hierarchical clustering results are dependent on the measure of distance and upon the method of linking, many different algorithms can be used to link or combine clusters based on various criteria. For example, in some algorithms, the profiles are linked and clusters are grown “from the bottom up,” though any linkage algorithm or clustering methodology known in the art may be used in the method of the present invention.

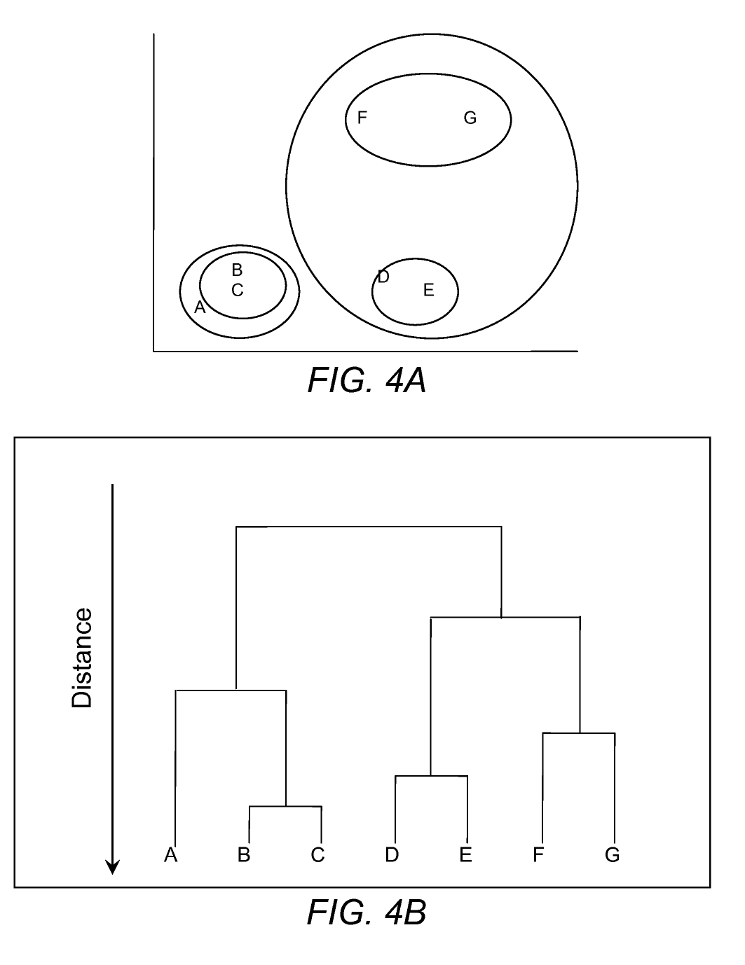

Aspects of hierarchical clustering are illustrated in FIGS. 4A and 4B. As shown in FIGS. 4A and 4B, the two profiles B and C are separated by the smallest distance and so are first to form a single linkage, and then that B/C cluster is linked to its nearest neighbor, in this case profile A. The separation distances and linkages form a cluster tree, often known as a dendrogram, such as the dendrogram shown in FIG. 4B. The hierarchy is grown by successive linking of clusters based on the smallest separation, such as the linking of profiles D and E and profiles F and G, and the linking of the D/E cluster to the F/G cluster. Each link may link one profile to another profile, one cluster to another cluster, or a profile to a cluster. As seen in FIG. 4B, each profile is represented along the horizontal axis of the dendrogram at the link distance along the vertical axis. Links are assigned based on the values of the attributes used in computing the link distance. The link distance between any two profiles (or clusters) is the sum of the two vertical distances (one up and one down) where the profiles (or clusters) are joined by a horizontal bar. The larger the sum (i.e., the longer the vertical distance before they are linked), the more separated the profiles (or clusters). The clustering process continues, as links are paired to form larger links until a hierarchical tree is formed with all clusters linked into a single cluster (sometimes called the main stem or root). This clustering tree is known as a dendrogram.

Dendrograms may reveal meaningful patterns that identifying natural groupings, reveal the appropriate number of clusters for the data, and identify profiles that are very much different from the other profiles. Thus, as described in more detail below, the method of the present invention can also be used to automatically identify anomalous data points in a database or verify the similarity of a new entry into the database as compared to existing entries.

In accordance with the present invention, this linkage and dendrogram creation process is automatically performed for each specified clustering trial. The linkages and dendrogram created for any one clustering trial may be different from the linkage and dendrogram created for any other trial, and comparing the dendrograms may provide information regarding which attributes most strongly affect the profiles being clustered. For example, the three dendrograms shown in FIG. 7A-7C, described in more detail below, were created from three different clustering trials using three different sets of intrinsic and extrinsic profile attributes, and exhibit very different linkages and clustering.

Evaluation of the dendrograms created by different clustering trials can be done by calculating the cophenetic correlation coefficient for each dendrogram. Thus, as shown in FIG. 2, at step 205 in a process flow according to the present invention, a cophenetic correlation coefficient c for each cluster trial can be automatically calculated so that the dendrograms from each trial can be evaluated. As is known in the art, the cophenetic correlation coefficient c provides a metric for the strength of the separation between clusters in a dendrogram resulting from hierarchical clustering. In the method of the present invention, the value of c for a clustering trial can be automatically compared to some threshold value or to the values calculated for one or more other trials to automatically identify the clustering trial that provides the best clustering, e.g., for use in the mission. The cophenetic correlation coefficient c is thus a measure of how faithfully the results of a particular clustering trial as reflected in the dendrogram represent the original dissimilarities among observations.

The cophenetic correlation coefficient c of a dendrogram comprising linked points {Tᵢ} can be calculated as

$$c = \frac{{\sum }_{i < j} ( x ( i , j ) - x ) ( t ( i , j ) - t )}{\sqrt{[ {\sum }_{i < j} {( x ( i , j ) - x )}^{2} ]} [ {\sum }_{i < j} {( t ( i , j ) - t )}^{2} ]}$$

where x(i, j)=|Xᵢ−Xⱼ|, the ordinary Euclidean distance between the ith and jth observations, t(i, j)=the height of the node at which these two points T₁ and Tⱼ are first joined together, x is the average of the distance x(i, j) and t is the average of the height t(i, j). See e.g., MATLAB Statistics Toolbox™ 7: User's Guide, pp. 17-207-17-208. The value of c depends only on the linkage between profiles and groups of profiles in a dendrogram and is independent of the number of clusters created. The value varies from 0 to 1; the higher the value of c, the more faithful the clustering is to the original observations, with the maximum value of 1 reflecting the highest quality solution. Thus, the trial having the highest value of c may present the most accurate clustering of the data, though as illustrated in the dendrograms shown in FIGS. 6A and 6B and as described in more detail below, more than one trial—i.e., more than one way of linking the data—may give nearly the same value of c. Depending on the mission or application, a dendrogram with only a slightly lower c value may be preferred due to the details of the dendrogram structure complexity. For example, the typical cascading nature of linkages may be more prevalent in one dendrogram than the other, and may provide additional information regarding the profiles being clustered.

Another possibility for using multiple trials with similar c values is to use PCA results form each individual trial to rank the combination of attributes used in all the trials to determine a new set of attributes and then re-cluster using those attributes. Thus, attribute selection for clustering could be performed in an iterative manner. Yet another possibility would be to count the number of times each attribute is used in the PCA determination for each trial and combine attributes that are used most frequently. Any of these variants can be used as appropriate to provide additional information regarding the nature of the profiles being clustered.

In accordance with the present invention, a threshold value of c, e.g., 0.85, can be selected for use in evaluating the linkages made and establishing cluster groups in a dendrogram. The threshold value of c can be determined in any number of appropriate ways. For example, in some embodiments, a threshold value of c can be automatically set as part of a mission plan, determined by one or more mission requirements or other predetermined criteria, while in other embodiments, the threshold value of c can be an arbitrary minimum value that applies to all clustering done for a particular set of data. In other cases, more than one threshold value of c can be used to evaluate the linkages so that more than one set of results is presented to the user. For example, if the coefficient of variation is computed for each dendrogram, it (or other such metrics) can be used as a measure of the complexity or order of the dendrogram structure or of the threshold linkages in the dendrogram. For a set of dendrograms with similar c values, the coefficient of variation could be used to determine which dendrogram is more applicable to the mission or application, a dendrogram with more complexity (or randomness) or one with more order.

As noted above, in cases where multiple clustering trials are run (for example, for different combinations of attributes, times, depths, missions, or applications), the threshold value of c can be used to automatically identify which trial exhibits the strongest clustering, i.e., has the greatest average distances between linkages. In such cases, clustering trials that do not have a high enough value of c (e.g., greater than the threshold value) can be removed from further analysis. If multiple trials have nearly the same c value, such as in the dendrograms shown in FIGS. 7A and 7B, this can indicate stability among the significant attributes used in the clustering trial and often can indicate lower variability or slower evolution of the profiles over the time and range scales included in the combined cluster matrix. Of course, even if only one clustering trial is run, the value of c can still be used to evaluate the strength of the clustering since c varies from 0 to 1 and a higher value of c indicates a stronger clustering.

At step 206 shown in FIG. 2 and as described in more detail below, in accordance with the present invention, linkage thresholds can be automatically generated and at step 207 one or more dendrograms showing the cluster groups created based on the linkage threshold values can be automatically generated. Exemplary dendrograms showing the different cluster groups created using different linkage values are shown in FIGS. 6A-6D and are described in more detail below.

In accordance with the present invention, the linkage thresholds can be automatically calculated based on the linkage values themselves and can then be used to automatically create cluster groups from the linked profiles. By basing the linkage thresholds on the actual linkage values, thresholds can be based on the naturally occurring groups and gaps in the linkage magnitudes rather than on arbitrary values or values based on the descriptive statistics. Thus, clustering in accordance with the present invention is robust and adaptive, and can more accurately reflect the actual relationships between clusters and provide better information regarding the underlying physical phenomena.

In addition, as noted above and as described in more detail below, different linkage thresholds can be used to automatically determine the fineness or scale of the resolution of the cluster groups as appropriate for different purposes, missions, or applications. For example, a high linkage threshold can be used to generate fewer clusters, each containing more linked profiles, whereas a low linkage threshold can be used to generate more clusters, even clusters that contain only a single value. In addition, linkage thresholds in accordance with the present invention can be used to automatically evaluate the validity of entries in a database. For example, clusters containing one or a very few values at a certain linkage threshold might contain outlier or otherwise invalid data values, and such clusters can automatically identified so that those values can be isolated or removed from consideration. Similarly, automatic clustering and analysis according to the present invention can be used when new entries in the database are added to verify the validity of such new entries by evaluating how well those entries are clustered with existing entries.

In addition, in accordance with the present invention, additional linkage values can be used to sub-cluster one or more specified cluster groups to obtain even finer resolution of specific clusters. A separate threshold can be found for each cluster group by using the same algorithm or procedure recursively, and so multiple threshold values can be found for a single dendrogram. For example, if after the initial thresholding of linkage magnitudes, the number of profiles in one cluster is particularly large, a second linkage threshold may be computed for the subset of linkages in that one cluster to form sub-clusters and so further refine the clustering in that group.

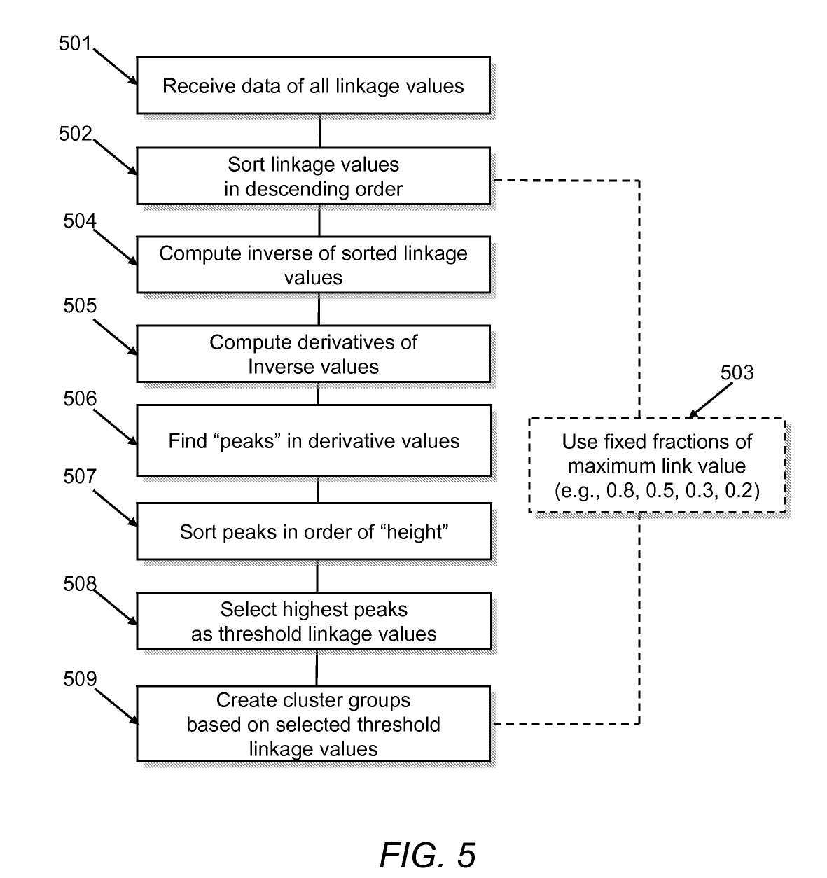

FIG. 5 depicts an exemplary process flow for calculating linkage threshold values and creating hierarchical clusters in an automated method for attribute-based adaptive data clustering in accordance with the present invention. In the method of the present invention, calculation of the linkage threshold values can be performed as soon as the linkages are created in the hierarchical linking steps described above all as part of a single process, can be calculated for later use, or can be performed on previously linked data that is loaded into memory, for example, as part of a mission plan. As noted above, in any of these cases, the threshold values can be calculated based on the actual linkages of profiles in the hierarchical linking and so provide a way of identifying one or more “natural” divisions in the dendrogram.

As illustrated in FIG. 5, in a first step 501 in a method for calculating a linkage threshold value in accordance with the present invention, data of all linkage values resulting from a hierarchical linking of profiles, for example, in a hierarchical linking as described above, is received by the computer and loaded into a memory. This step can be either part of a continuous hierarchical linking and analysis process, and thus the data of the linkage values is already resident in the computer's memory, or can be a separate process in which data of previously linked profiles is loaded into the computer for identification of cluster groups, for example, identification of cluster groups to be used for a particular mission. At step 502, the linkage values are sorted in descending order so that a maximum linkage value and a minimum linkage value can be identified.

In some embodiments of the method for calculating a linkage threshold value, the threshold value can be automatically calculated from the derivative of the linkage values. Thus, in such embodiments, after the linkage values are sorted in descending order at step 502, at step 504 the inverse of each of the sorted values is computed, and at step 505, the numerical derivative of each of the inverse values is computed. At step 506, the derivatives are used to identify the relative “peaks,” i.e., maxima, in the link distances. These maxima are presumed to represent the most natural locations to threshold the dendrogram, i.e., threshold values that correspond to the naturally occurring steps or jumps in the dendrogram linkages. At step 507, these maxima are sorted based on their relative magnitudes and linkage values, and at step 508 the location of each relative maxima is set as one threshold value that can be used at step 509 to create the cluster groups in the dendrogram. Each relative maxima identifies a single unique threshold value in the dendrogram. In some embodiments, a minimum number of such maxima that should be found can be predefined, for example, as part of the clustering script, and if such a minimum number of peaks are not found, as shown in step 503, one or more linkage threshold values can be calculated as any fixed fraction of the maximum linkage value, e.g., 0.8, 0.5, 0.3, and/or 0.2, and the threshold value so calculated can be used then used at step 509 to create the cluster groups. In other embodiments, this type of “fixed fraction” linkage threshold can be used as an alternative to calculating the threshold value based on the linkage derivatives, for example, as a standalone requirement or as part of a larger mission plan where achieving a particular “fineness” of resolution of the clustering is desired.

Irrespective of how the linkage threshold value is determined, the threshold value represents a horizontal line across the entire dendrogram and determines which profiles get partitioned into which cluster group. Each vertical line in the dendrogram immediately below the threshold value defines a unique cluster group, and all profiles linked to that vertical line are assigned the same cluster group identification number.

Once the cluster groups have been created from partitioning the linkages below the threshold value, the computer can generate one or more graphical outputs such as dendrograms, maps, or any other appropriate output showing the results of the clustering. For example, dendrograms can be generated that provide a visual indication of the cluster groups, either by use of different colors, different patterns, or any other appropriate means. As noted above, dendrograms may reveal meaningful patterns that identify natural groupings, may reveal the appropriate number of clusters for the data, and may identify profiles that are significantly different from the other profiles. By analyzing these dendrograms, the clusters containing only a few profiles can be readily identified, providing a means of automatically identifying potential anomalous entries in a database or of verifying the validity or usefulness of new entries by comparing how the new entries are clustered compared to older entries.

In addition, based on the cluster groups identified, e.g., for a particular mission type, the number of profiles in any one cluster group can provide an indication of where and when profiles may need to be acquired to bolster the statistical value of the database and where and when new profiles might not be needed because they do not add much new information. In this manner, automated data clustering in accordance with the present invention can enable mission planners to more effectively allocate their resources to those activities/areas having the greatest impact.

FIGS. 6A-6D and 7A-7C depict two exemplary sets of dendrograms that reflect one or more aspects of the present invention.

A first exemplary set of dendrograms showing clustering of sound speed profiles generated in accordance with the method of the present invention is shown in FIGS. 6A-6D. In FIGS. 6A-6D, the same dendrogram is replicated four times and provides a visual identification, in this case grayscale-coding, to show the sorting of profiles into cluster groups based on different linkage threshold values shown by the dotted horizontal black lines. The number of resulting clusters is shown at the top of each dendrogram next to the word “mynoc,”, and thus FIG. 6A (“mynoc7”) has 7 clusters while FIG. 6D (“mynoc126”) has over 100 cluster groups generated from approximately 3000 profiles.

FIG. 6A shows the cluster groups generated using a linkage threshold value of about 1.3. With clustering at this threshold linkage, most (approximately 79%) of the profiles fall into one cluster group, i.e., the group shown on the right hand side of the dendrogram of FIG. 6A. Approximately 19% of the profiles fall in the second largest group, with the other three groups that together represent about 2.5% of the profiles being too small to be seen clearly at this scale. The 2.5% of the profiles are not necessarily outliers in the standard deviation sense, just one or more profiles separated by large link values to the other profiles. These smaller groups could indicate the natural variability in the sound speed profiles being clustered, or could indicate the need for more cluster groups. As the linkage threshold decreases in FIGS. 6C and 6D, the number of cluster groups increases. In addition, as the threshold goes lower, the density of profiles in each cluster group becomes more evenly distributed.

The links above the threshold are also revealing. The horizontal bars indicate what varying threshold values will separate what profiles into distinct clusters. Profile differences are identified by these links. Where horizontal and vertical distances are large, profiles are more strongly separated. Where vertical links are short, cascading consistently with little vertical separation, this structure is a sign of evolving changes and these clusters are weakly separated. Thus, many deep vertical nulls are a sign of cluster group separation, and short vertical links indicate a condition of diminishing returns on the optimal number of cluster groups. The dendrogram plot provides the operator with the visual clues for setting the thresholds based on experience and intuition (but requires interaction). FIGS. 6B, 6C, and 6D show the results of clustering at increasingly lower thresholds (dashed horizontal lines) that separate profiles into increasingly more cluster groups.

The threshold value of the dendrogram shown in FIG. 6D results in 40 distinct cluster groups, with several groups containing less than 1% of the profiles each. The process of multiple thresholding for a single dendrogram provides a tradeoff in cluster group resolution for the profiles in the database and the total number of cluster groups that must be analyzed and managed. The distribution of profiles among cluster groups provides opportunities for determining the numbers of cluster groups based on the mission or application in which the clustering is to be used. For example, a large number of cluster groups can be very useful for identifying at anomalous profiles, and can allow the analyst to identify which cluster group(s) are important for further consideration or study for profile variance. On the other hand, a smaller number of profiles can be sufficient if the mission requires identifying only the major profile trends and profile characteristics. In accordance with the present invention, a mission plan can thus define a minimum or maximum resolution scale based on the number of clusters and the cluster density distribution that are of interest, and the computer can use this information in determining which of the possible threshold linkages to output to the user.

FIGS. 7A-7C depict three different dendrograms generated using three different trials defined by different combinations of intrinsic and extrinsic attributes:
FIG. 7A: a fixed set of intrinsic and extrinsic attributes of the profiles was subjected to principal component analysis and the results used for the trial;
FIG. 7B: all intrinsic and extrinsic attributes of the profiles were subjected to principal component analysis and the results used for the trial;
FIG. 7C: only intrinsic attributes of the profiles were used for the trial, without extrinsic attributes and subjected to principal component analysis.

The values of the cophenetic correlation coefficient c for the dendrograms created from each clustering trial are 0.92504, 0.91014, and 0.86361 for FIGS. 7A, 7B, and 7C, respectively. Thus, the dendrogram in FIG. 7A has the highest value of c and so the clustering parameters used to create the dendrogram in FIG. 7A may be considered to provide the best representation of the original similarities and dissimilarities in the profiles being clustered.

In addition, as can be seen from the dendrograms shown in FIGS. 7A-7C, in accordance with the present invention which calculates linkage threshold values from the linkage values themselves, the different parameters used in the different clustering trials resulted in different linkage threshold values for each dendrogram, i.e., about 0.55 for FIG. 7A, about 0.75 for FIG. 7B, and about 0.58 for FIG. 7C. These different linkage threshold values yield a different number of cluster groups in each dendrogram, with each cluster group being identified by a different shading in the figure. For example, the linkage threshold of 0.55 in FIG. 7A resulted in the creation of 19 cluster groups (“mynoc19”), the linkage threshold of 0.75 in FIG. 7B resulted in 25 cluster groups, and the linkage threshold of 0.58 in FIG. 7C resulted in 26 cluster groups. Thus, for some applications, the dendrogram in FIG. 7C, despite its having a lower cophenetic correlation coefficient value, may provide better information regarding the profiles due to the larger number of cluster groups created from the linkages.

However, it can also be seen that in all three cases, the majority of profiles still fall into a few clusters with many profiles. This indicates that over some attribute values the profiles are similar while for other attributes the profiles are quite different. Principal components help rank the significance of each attribute and the linkage ranks profile similarity. Taken together, an indication is provided as to which attributes at what locations are controlling the profile evolution within a cluster group. For example, the branching for high values of linkage (y-axis) in FIGS. 7A-7C are very different, while at lower values, the dendrograms have similar cascading structures. The identification of the attributes responsible for the linkage patterns or structures at one location can be compared to other locations (or times) and provides new insight into the processes behind the evolving profiles.

Thus, in a given mission situation it may be desirable to analyze the linkages created in each clustering trial to identify the clustering trial that produces clusters which more accurately reflect the known physical evolutions reflected in the data or to create cluster groups that may be most useful to the mission at hand. The present invention automatically performs such an analysis as part of the clustering script.

The results of the automated method for attribute-based adaptive data clustering in accordance with the present invention can be used to generate many other visualizations that may be of great interest to a user. For example, FIGS. 8A-8D depict plots of the sound speed profiles for four different clusters identified using the method of the present invention. FIG. 8A depicts plots of the profiles in three cluster groups having the most profiles as determined by the automated processing. The profiles included in the most densely populated cluster group are shown in 8A with sound speed along the horizontal axis and depth below the sea surface along the vertical axis. The profiles in the second most populated cluster group are shown in FIG. 8B, and the third most populated in FIG. 8C. The invention has automatically separated the profiles into three most natural basic shapes. The profiles depicted in FIG. 8A show a small arc as a function depth with a higher sound speed values near the surface. FIG. 8B shows the second group of profiles that have little or no curvature and 8C, the lowest density of profiles have a knee-shape near the 50 meter depth where the sound speed was increasing above the knee and decreasing with depth below the knee. FIG. 8D shows the least-populated cluster group and shows that there is little conformity in the spatial distribution of those profiles, and that those profiles might be examined further as representing either outlier values or profiles representing anomalous events.

The results of the clustering of data in accordance with the present invention can also be used in many other ways that can illustrate or reveal the characteristics inherent in the profiles by the clustered results. For example, FIG. 9 depicts a spatial map showing the distribution of the sound speed profiles clustered in accordance with the present invention and illustrated in FIGS. 8A to 8D. In the spatial map shown in FIG. 9, only those clusters containing more than 1% of the total number of profiles are included, which in this case limits the map to a few clusters, though of course any criteria can be used to select the number and identity of cluster groups used In the northern Gulf of Mexico map shown in FIG. 9, each cluster group is assigned a unique color or symbol so the cluster groups of sound speed profiles can clearly be seen. The largest density cluster group of profiles 901 (i.e., the group shown in FIG. 8A) appear in the deeper regions of the ocean, generally the furthest away from the coastline. The profiles in the second largest cluster group 902 (i.e., the group shown in FIG. 8B) are sparsely scattered throughout the coastline. The profiles in the third group 903 (shown in FIG. 8C) occurs mostly in the south Texas area, and a fourth group 904 (shown in FIG. 8D) is found only in Mobile, Bay, Ala. Locations where the different cluster group meet and intermingle indicate high potential for variability in sound speed and a significant change on sonar operating conditions.

Cluster maps such as those shown in FIG. 9 indicate locations where the historic sound speed changes are sufficient to effect sonar performance (although the effect's magnitude is dependent on geometry, sonar frequency, and range of interest). This can aid in survey operations as ships transit from one location to another and provide clues for ship operations. Such maps can also help planners customize conductivity/temperature/depth (CTD) and bottom grab sample locations so as to avoid locations which require a ship to stop activities such as surveying or mine hunting. Sound velocity profile (SVP) cluster maps can help fleet mine countermeasures (MCM) planners optimize ship's operations in much the same way and in addition provide for more efficient planning of different MCM sonar usage due to the historic variability in SVPs.

The present invention thus provides a fully automated, consistent, and repeatable clustering method that can provide robust, adaptive, attribute-based clustering of data in a database. The clustering parameters can be tailored to the needs of a particular mission or application as part of a mission plan or can be set by an operator to obtain desired information regarding entries in the database. Clustering in accordance with the present invention can reveal similarities or variations in the database that might not be otherwise found, and can provide location/date/time information relating to those similarities and differences.

It should be appreciated that one or more aspects of a method for automated attribute-based adaptive data clustering as described herein can be accomplished by executing one or more sequences of one or more computer-readable instructions read into a memory of one or more computers from volatile or non-volatile computer-readable media capable of storing and/or transferring computer programs or computer-readable instructions for execution by one or more computers. Volatile computer readable media that can be used can include a compact disk, hard disk, floppy disk, tape, magneto-optical disk, PROM (EPROM, EEPROM, flash EPROM), DRAM, SRAM, SDRAM, or any other magnetic medium; punch card, paper tape, or any other physical medium such as a chemical or biological medium. Non-volatile media can include a memory such as a dynamic memory in a computer.

Although particular embodiments, aspects, and features have been described and illustrated, it should be noted that the invention described herein is not limited to only those embodiments, aspects, and features. It should be readily appreciated that these and other modifications may be made by persons skilled in the art, and the present application contemplates any and all modifications within the spirit and scope of the underlying invention described and claimed herein.

What is claimed is:

1. A computer-implemented method for automated data clustering, comprising:
receiving data representing a plurality of entries in a database;
transforming each entry into data representing a plurality of intrinsic attributes of the entry;
receiving data representing at least one extrinsic attribute of the entries in the database;
receiving data defining a clustering trial to be run on the entries in the database, a definition of the clustering trial including a predetermined subset of the intrinsic and extrinsic attributes of the entries in the database;
automatically performing principal component analysis on the predetermined subset of attributes to be used in clustering the database entries to identify a set of significant intrinsic and extrinsic attributes to be used in clustering the entries in the database;
automatically linking the entries in the database based on the significant attributes to create a dendrogram comprising a plurality of hierarchical linkages, each linkage in the dendrogram being based on a computed distance between each entry using the significant attributes to compute distance;
automatically calculating a linkage threshold value based on the calculated linkage values; and
automatically grouping the linked entries in the database into a plurality of clusters in accordance with the linkage threshold value;
wherein the data of the entries in the database is transformed into data of the plurality of clusters; and
wherein the grouping of entries in the database into clusters reflects a similarity of the entries based on the significant attributes used to create the hierarchical linkages.

2. The method for automated attribute-based data clustering according to claim 1, wherein the entries in the database comprise data profiles, each profile comprising a function of spatial and temporal attributes.

3. The method for automated attribute-based data clustering according to claim 1, wherein the entries in the database comprise water temperature-salinity-depth profiles.

4. The method for automated attribute-based data clustering according to claim 3, wherein the clustering trial is based on a subset of attributes relating to at least one of date, location, and water depth structure.

5. The method for automated attribute-based data clustering according to claim 1, wherein the entries in the database comprise underwater sound speed profiles.

6. The method for automated attribute-based data clustering according to claim 1, wherein the grouping of entries into clusters provides information regarding at least one of an evolution of the entries in the database.

7. The method for automated attribute-based data clustering according to claim 6, wherein the evolution of the entries in the database comprises one of an evolution of location, an evolution of depth, and an evolution of time.

8. The method for automated attribute-based data clustering according to claim 1, wherein the linkage threshold value is specific to one of a mission and an application in which the clustering is used.

9. The method for automated attribute-based data clustering according to claim 1, further comprising:
performing a plurality of clustering trials, a definition of each of the clustering trials including a corresponding subset of intrinsic and extrinsic attributes;
creating a corresponding plurality of dendrograms based on the plurality of clustering trials;
automatically calculating a cophenetic correlation coefficient of each dendrogram; and
comparing the values of the calculated cophenetic correlation coefficients to automatically identify the most significant set of attributes for the database entries.

10. The method for automated attribute-based data clustering according to claim 1, further comprising receiving data representing a predefined mission plan, wherein the definition of the clustering trial is received as part of the mission plan.

11. The method for automated attribute-based data clustering according to claim 10, wherein the definition of the clustering trial includes at least one of a spatial, temporal, evolutionary, and cluster density scale of interest.

12. The method for automated attribute-based data clustering according to claim 10, wherein at least one attribute used in clustering the data is preselected by the mission plan.

13. The method for automated attribute-based data clustering according to claim 1, further comprising:
automatically identifying a maximum linkage value of the linkages in the dendrogram; and
automatically calculating the linkage threshold value as a fixed fraction of the maximum linkage value structure to control at least one of a cluster group resolution and a cluster group density.

14. The method for automated attribute-based data clustering according to claim 1, further comprising:
automatically calculating an inverse of a value of each linkage in the dendrogram to obtain a plurality of inverse linkage values;
automatically calculating a derivative of each inverse linkage value;
automatically comparing the inverse linkage values to a predetermined evaluation criteria and identifying a peak value that corresponds to the most natural linkage threshold to partition the entries into cluster groups based on the largest separations in the linkage values.

15. The method for automated attribute-based data clustering according to claim 1, further comprising:
automatically calculating a plurality of linkage threshold values; and
automatically grouping the linked entries in the database into a plurality of cluster groups in accordance with each linkage threshold value to form a plurality of cluster groupings;
wherein a number of the clusters in each grouping is determined by a corresponding linkage threshold value.

16. The method for automated attribute-based data clustering according to claim 15, wherein the number of linkage threshold values is predetermined as part of a mission plan.

17. The method for automated attribute-based data clustering according to claim 1, further comprising:
automatically generating and outputting at least one graphical rendering indicative of the grouping of the entries in the database.

18. The method for automated attribute-based data clustering according to claim 1, further comprising:
identifying a subset of database entries forming one of the cluster groups; and
running a second clustering trial on the subset of entries to further refine the clustering of the data in the database.

19. The method for automated attribute-based data clustering according to claim 18, wherein the second clustering trial is based on a mission-specific subset of attributes.

20. A computer-implemented method for automatically evaluating entries in a database, comprising:
receiving data representing a plurality of entries in a database;
transforming each entry into data representing a plurality of intrinsic attributes of the entry;
receiving data representing at least one extrinsic attribute of the entries in the database;
receiving data defining a clustering trial to be run on the entries in the database, a definition of the clustering trial including a predetermined subset of the intrinsic and extrinsic attributes of the entries in the database;
automatically performing principal component analysis on the predetermined subset of attributes to be used in clustering the data base entries to identify a set of significant intrinsic and extrinsic attributes to be used in clustering the entries in the database;
automatically linking the entries in the database based on the significant attributes to create a dendrogram comprising a plurality of hierarchical linkages, each linkage in the dendrogram being based on a computed distance between each entry using the significant attributes to compute distance;
automatically calculating a linkage threshold value based on the calculated linkage values;
automatically grouping the linked entries in the database into a plurality of cluster groups in accordance with the linkage threshold value, wherein the data of the entries in the database is transformed into data of the plurality of clusters; and
automatically identifying at least one potentially anomalous entry in the database as a result of the grouping, the anomalous entry being in a cluster group comprising fewer than a predetermined valid number of entries.

21. The method for evaluating entries in a database according to claim 20, further comprising automatically removing the identified anomalous entries from the clustering.

22. The method for evaluating entries in a database according to claim 20, further comprising automatically isolating the identified anomalous entries from the remaining entries in the database.

23. The method for evaluating entries in a database according to claim 20, wherein at least one of the entries in the database is a new entry.

24. The method for evaluating entries in a database according to claim 20, wherein the anomalous entry is a new entry in the database.

25. A computer-implemented method for evaluating attributes of entries in a database, comprising:
receiving data representing a plurality of entries in a database;
transforming each entry into data representing a plurality of intrinsic attributes of the entry;
receiving data representing at least one extrinsic attribute of the entries in the database;
receiving data defining a plurality of clustering trials to be run on the entries in the database, a definition of each clustering trial including a predetermined subset of the intrinsic and extrinsic attributes of the entries in the database;
for each clustering trial, automatically performing principal component analysis on the predetermined subset of attributes to be used in clustering the data base entries to identify a set of corresponding significant intrinsic and extrinsic attributes to be used in clustering the entries in the database in the corresponding clustering trial;
automatically running each clustering trial to link the entries in the database based on the corresponding significant attributes for each clustering trial to create a corresponding plurality of dendrograms, each dendrogram comprising a plurality of hierarchical linkages, the linkages being based on a computed distance between each database entry using the corresponding significant attributes to compute distance;
for each corresponding dendrogram, automatically calculating a linkage threshold value based on the calculated linkage values;
for each corresponding dendrogram, automatically grouping the linked entries in the database into a plurality of clusters in accordance with the linkage threshold value, wherein the data of the entries in the database is transformed into data of the plurality of clusters and wherein the grouping of entries in the database into clusters reflects a similarity of the entries based on the significant attributes used to create the hierarchical linkages;
automatically calculating a cophenetic correlation coefficient of each corresponding dendrogram;
comparing the values of the calculated cophenetic correlation coefficients to automatically identify the most significant set of attributes for the database entries; and
relinking the entries in the database according to the identified most significant set of attributes for the database entries.

26. A computer-implemented method for evaluating attributes of entries in a database, comprising:
receiving data representing a plurality of entries in a database;
transforming each entry into data representing a plurality of intrinsic attributes of the entry;
receiving data representing at least one extrinsic attribute of the entries in the database;
receiving data defining a plurality of clustering trials to be run on the entries in the database, a definition of each clustering trial including a predetermined subset of the intrinsic and extrinsic attributes of the entries in the database;
for each clustering trial, automatically performing principal component analysis on the predetermined subset of attributes to be used in clustering the data base entries to identify a set of corresponding significant intrinsic and extrinsic attributes to be used in clustering the entries in the database in the corresponding clustering trial;
identifying the intrinsic and extrinsic attributes most frequently identified as significant attributes over all the clustering trials; and
linking the entries in the database based on the most frequently identified significant attributes.
